(19) United States
(12) Patent Application Publication
(10) Pub. No.: US 2024/0393363 A1
(43) Pub. Date: Nov. 28, 2024

(54) ACTIVE DITHER BALANCING OF A MOTION STAGE FOR SCANNING PROBE MICROSCOPY

(71) Applicant: Nearfield Instruments B.V., Rotterdam (NL)

(72) Inventors: Massoud Hemmasian Ettefagh, Maassluis (NL); Hamed SADEGHIAN MARNANI, Rotterdam (NL)

(21) Appl. No.: 18/697,040

(22) PCT Filed: Sep. 30, 2022
(86) PCT No.: PCT/NL2022/050547

§ 371 Date: Mar. 29, 2024

(30) Foreign Application Priority Data
Oct. 1, 2021 (NL) 2029303

(51) Int. Cl. G01Q 70/04

(52) U.S. Cl. CPC G01Q 70/04

(57) ABSTRACT

The present disclosure concerns a z-position motion stage for use in a scanning probe microscopy system, a scanning probe microscopy system, and a method of operating the motion stage. The motion stage (1) comprises, a scanner body (10) and a driving dither (30) for driving a cantilever (51) of a probe (50) associated to the driving dither in an oscillating motion (31). The stage further comprises at least a first force balancing means (60), that acts onto the scanner body at a position opposite the driving dither (30) across a neutral center (N) of the motion stage (1), wherein the force balancing means (60) comprises at least a first balance dither (61) configured to oscillate in harmony with the driving dither.

### TECHNICAL FIELD AND BACKGROUND

The present disclosure relates to a motion stage for use in a scanning probe microscopy system, in particular to a z-position motion stage having a scanner body and a dither for driving a cantilever of a probe in an oscillating motion.

The present disclosure further relates to a scanning probe microscopy system comprising a motion stage, in particular to a system comprising a motion stage having a scanner body and a dither for driving a cantilever of a probe in an oscillating motion.

The present disclosure is further directed to a method of operating a scanning probe microscopy system or position motion stage, in particular to a system or motion stage having a scanner body and a dither for driving a cantilever of a probe in an oscillating motion.

Scanning probe microscopy (SPM) concerns a widespread class of microscopy methods that is based upon the scanning of a surface by means a probe tip that is kept in continuous or periodic, i.e. intermittent, contact with a surface to be probed. The method enables the detection and mapping of surface factures—e.g. trenches, dimples, edges, roughness, etcetera—and subsurface features of a sample with great accuracy and at high resolution. The high resolution enables the detection of nanometer sized structures, and as a result of this high resolution has become very popular for example as a tool in the production of semiconductor elements. However, SPM is used in many other applications as well, for example the imaging and analysis of soft tissue or biological samples.

Scanning probe microscopy systems are typically provided with a scan head or motion stage in order to provide relative motion (xyz) between a substrate to be probed and a probe tip, for example a tip of a probe at a working end of a cantilever, associated to the motion stage. Generally the motion stage includes a means, e.g. a holder, for reversibly holding one or more probe chips, typically including a probe tip positioned at or near an end of a cantilever of the probe chip. The cantilever is typically driven by an actuator, generally referred to as a dither, acting on the probe chip, e.g. via the holder, so as to provide a periodic, oscillating, motion to the cantilever with a known amplitude for interaction with the surface.

To provide a relative motion, e.g. a scanning motion, between a probe tip, e.g. a driven probe tip, and a surface of a substrate to be probed the motion stage is typically provided with one or more fine translation means or actuators, typically piezo driven actuators. To reduce a separation distance between a probe tip, e.g. a driven probe tip, and a surface of a substrate to be probed the motion stage typically includes a coarse and a fine translation means. The coarse stroke actuator is generally referred to as a large stroke actuator or a large stroke z-positioning actuator. Due to its comparatively high mass large stroke actuations can cause imbalances or parasitic oscillations within a scan head. To mitigate imbalances to a large stroke actuation U.S. Pat. No. 6,590,208 discloses a balanced momentum probe holder comprising first and second actuators at opposing ends that either both extend or retract in response to a signal from a detector. WO2019070120 concerns a z-position motion stage for use in an SPM system comprising a support element with an actuator that enables precise motion in the z-direction for following a sample topology and that is shaped rotation symmetric around a notional common longitudinal axis so as to provide a high intrinsic stiffness. In an embodiment that also includes a balance actuator, a second identical motion actuator, the support element is also symmetric with respect to a plane perpendicular to the longitudinal axis. This additional symmetry is reported to cause the support element to be in balance in the z-direction, improving the dynamic behavior thereof in use. As background, U.S. Pat. No. 6,323,483 describes a high bandwidth recoiless microactuator. In particular, U.S. Pat. No. 6,323,483 concerns increasing the bandwidth of its Z-positioning actuator.

A potential disadvantage of providing a driving dither onto or along a motion stage is that, during operation, the motion stage itself generally also experiences a net resultant force imposed by the driving dither, which depending on the circumstance may cause a noticeable displacement with can cause inaccuracies during scanning probe microscope operation. This displacement may be particularly detrimental to scanning probe microscope performance if the driving dither is operated at a frequency that matches or overlaps with a resonance mode or eigen frequency of the scanner. To circumvent or mitigate noticeable displacement or resonance of the scanner, the scanner may be dimensioned and/or shaped, to reduce resonance along a particular direction within a given frequency range. To this end known scanners, such as disclosed by U.S. Pat. No. 5,574,278, are typically designed with a comparatively stiff body or casing. Alternatively, or in addition, lateral displacement or resonance at the stage level induced by the driving dither of known stages can be reduced by positioning of the probe holder and/or driving dither at or near a longitudinal axis of symmetry of the stage. The above design criteria seriously restrict a design or form-factor of the scanner body and correspondingly of the scanning probe microscopy system.

### SUMMARY

It is an object of the present disclosure to mitigate one or more of the above disadvantages and to provide a motion stage and/or scanning probe microscopy system that can be operated with improve accuracy.

It is another or further object to provide a motion stage and/or scanning probe microscopy system that allows for more relaxed conditions as to its shape and/or dimensioning.

Aspects of the present disclosure relate to a z-position motion stage, in particular for use in a scanning probe microscopy system, that comprises a scanner body and a driving dither. The driving dither is configured to impart a first oscillation for driving a cantilever of a probe associated to the driving dither in an oscillating motion. The driving dither can be provided along a first terminal end face of the scanner body at a position near a first edge thereof. The stage further comprises at least one force balancing means acting onto the scanner body at a position opposite the driving dither across a stationary or neutral center of the motion stage. The stationary or neutral center of the scanner body can refer to a neutral bending plane along a longitudinal axis of the scanner body 10. The force balancing means comprises at least one balance dither configured to oscillate in harmony with the driving dither.

The balancing means, unless specified otherwise herein generally referred to as first balancing means, at its position opposite the driving dither across the stationary or neutral center of the motion stage can advantageously generate a resultant force that acts onto the scanner body in a direction opposite to a resultant force of the driving dither onto the scanner body, even when the driving dither is operated at a frequency that overlaps or coincides with a resonance mode of the z-position motion stage.

Depending on geometry of the z-position motion stage and/or the targeted resonance mode the stationary or neutral center of the z-position motion stage may be considered to be a center of mass of the z-position motion stage. Alternatively, or in addition, the stationary or neutral center of the z-position motion stage may be defined by a point, an axis, and/or plane where the z-position motion stage is connected (fixed) to a stationary reference point, typically a metro frame of the scanning probe microscopy system.

The balance dither is preferably operated in harmony with the driving dither. Operating the balance dither in harmony with the driving dither maximizes an effective counter force and/or reduces undesired resonance of the z-position motion stage.

In a preferred embodiment, the z-position motion stage is configured with a first force balancing means arranged to at least partly counteract a nodding or bending resonance of the scanner body which, when unchecked, may cause undesired rotational error and/or displacements of the scanner body in a direction along a lateral scanning direction (xy) relative to the substrate to be probed.

In other or further preferred embodiments the first force balancing means is arranged to at least partly counteract a stretching or breathing resonance of the scanner body (expansion or compression of the body along a longitudinal axis of the scanner body). Mitigating resonances along a longitudinal direction of the scanner body, generally in line with a direction of coarse translational motion (z), e.g. to reduce an initial separation distance between a probe across a surface to be probed, improves accuracy during operation.

In a preferred embodiment the first force balancing means is provided along the first terminal end face of the scanner body at a position opposite the driving dither across a stationary or neutral center of the motion stage. Accordingly, the first force balancing means can understood to be arranged to, in use, at least in part cancel out a resultant force imposed onto the scanner body by the driving dither. Cancelling out or at least reducing a net resultant force onto the scanner body mitigates a nodding or bending resonance of the scanner body which mitigates undesired lateral and/or vertical and/or rotational parasitic displacement of the scanner along said face, which may show up as disturbances during a scanning operation.

Positioning the driving dither and the balancing means at opposing positions along a first terminal end face of the scanner body advantageously allows positioning the driving dither and/or means for holding a probe in an off-center position, or even near an edge, of the scanner body while still mitigating undesired resonances of the scanner body. Positioning the driving dither and/or means for holding a probe in an off-center position, or even near an edge of a first terminal end face of the scanner body can be advantageous for a number of reasons including, but not limited to providing enough space for optical path.

In another or further preferred embodiment, the force balancing means is positioned along a second terminal end face of the scanner body opposite the first terminal end face. Accordingly, the force balancing means can be considered to be positioned relative to the driving dither so that, in use, an induced resultant force as generated by the balancing means at least partly cancels out a resultant force induced by the driving dither in a direction along a longitudinal direction of the scanner body between the first and second first terminal end faces. As such, said embodiments were found to at least partly counteract a stretching or breathing resonance of the scanner body, e.g. in a direction along a longitudinal axis of the scanner body between the first and second terminal end faces.

Advantageously, in some preferred embodiments the z-position motion stage can be configured with a plurality of force balancing means arranged to at least partly counteract a resonance mode of the stage along any principal geometrical direction (xyz) and/or to at least partly counteract a resonance having components along multiple principle directions.

In a particular preferred embodiment the motion stage comprises a first and a second force balancing means that are respectively provided along the first terminal end face and along the second terminal end face of the scanner body at positions opposite the driving dither across a stationary or neutral center (N) of the motion stage. As such, said embodiment may be understood to be configured to at least partly counteract displacements due to a plurality of resonance modes of the scanner body, e.g. a bending and a stretching resonance or even a complex resonance having components along multiple principle directions.

The first and second force balancing means respectively comprise one or more balance dithers configured to oscillate in harmony with the driving dither.

In a preferred embodiment, the second balance means comprises at least two second balance dithers distributed at positions along the second terminal end face opposite the driving dither and the first force balancing means. Provision of at least two second balance advantageously further allows mitigating potential stretching resonances, e.g. due to forces by the driving dither and the first force balancing means. Alternatively, or in addition, provision of at least two second balance dithers allows mitigating a potential nodding or bending resonance along a bottom portion of the scanner body, e.g. in a direction along the second terminal end face of the scanner body.

In particularly preferred embodiments the scanner body comprises a first end member that defines the first terminal end face and a second end member that defines the second terminal end face. The first and second end members are positioned across opposite ends of central member, whereby each of the first and second end members is attached to the central member by one or more spring members, e.g. a spring blade. The central member advantageously comprises a large stroke actuator that acts on the first and second end members so as to provide a translational motion in a direction transverse, preferably orthogonal, to the first terminal end face. The scanner body is reversibly connectable to a metro frame of the scanning probe microscopy system, preferably via the central member, for example by a mount provided along the central member, so as to provide the z-position motion stage with a stable reference point at least during operation of the long stroke actuator. The one or more spring members advantageously provide the scanner body with a compliance for the translational motion. It will be appreciated that provision of the first and/or second balancing means according the present disclosure is particularly effective in mitigating undesired resonance modes of the z-position motion stage, which as compared to stages with a comparatively stiffer scanner body can be particularly prone resonances, e.g. bending modes, in a frequency range relevant for actuating a cantilever of typical commercially available probe chips.

Other or further aspects of the present disclosure relate to a scanning probe microscopy system. In particular a scanning probe microscopy system comprising a z-position motion stage to the present disclosure, and that preferably further comprise a mount for reversibly associating said z-position motion stage to a metro frame of the scanning probe microscopy system.

Yet further or other aspects of the present disclosure relate to a method of operating a scanning probe microscopy system or of operating a z-position motion stage according to the present disclosure. The method comprises at least: associating a probe to the z-position motion stage; and driving the driving dither, typically at a target driving frequency associated with a target resonance mode of a cantilever of the probe; and operating the first force balancing means in harmony with the driving dither at least while the driving dither is driven at a frequency associated with a resonance mode of the scanner body. Driving the driving dither and the first force balancing means in harmony as disclosed herein advantageously mitigates parasitic motion, e.g. during probing an area of a substrate of interest, due to undesired translations from an resonance mode of the scanner body.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1A depicts an stages of an exemplary resonance of a scanner during operation;

FIG. 1B depicts a top view of an embodiment of a scanner;

FIG. 1C illustrates the displacement of a cantilever and scanner body as function of driving frequency;

FIGS. 2A, 2B and 2C provide partial side views of embodiments of a scanner with a force balancing means

FIG. 3A to 3C provide schematic top views of other or further embodiments of a scanner with a force balancing means;

FIGS. 3D and 4A provide schematic side-views of embodiments of a scanning probe microscopy system comprising yet other or further embodiments of a z-position motion stage; and

FIGS. 4B and 4C provide schematic side-views of even further or other embodiments of a z-position motion stage.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

As used herein the term dither can be understood to as an actuator, typically comprising a piezo electric actuator or a stack of piezoelectric actuators configured to provide an oscillating motion to a probe chip at a frequency range, typically but not exclusively in a range encompassing 5 kHz to 500 kHz or 10 kHz to 1 MHz, so as to excite a resonance mode of a cantilever of the probe chip. A large stroke actuator in contrast is configured to provide comparatively larger and slower displacements so as to position a probe, e.g. a probe held and excited by the dither, relative to a substrate, for example in dependence of a control parameter such as resonance amplitude.

The term operating ‘in harmony’ as used herein can be understood to encompass operating at essentially the relevant frequency. As will be clear from the description the phase difference can depend on a number of aspects including but not limited to: rigidity or compliance of the scanner, positioning of the balancing means and the driving dither relative to a stationary or neutral center of the scanner body and/or a target resonance mode of the scanner to be mitigated. For example, presuming a rigid scanner behavior, it will be understood that the first force balancing means is preferably driven essentially in-phase with the driving dither, so as to mitigate a potential bending or nodding oscillation of the z-position motion stage by at least partly compensating a resultant force imposed onto the body by the driving dither. Likewise it will be understood that a force balancing means that is positioned across a rigid scanner body opposite a driving dither, e.g. along the second terminal end face of the scanner body opposite the first face, is preferably operated so as to mitigate a potential stretching or breathing oscillation of the z-position motion stage by at least partly compensating a longitudinal resultant force imposed onto the body by the driving dither. It will be understood that if the scanner includes elements with non-linear behavior, such as dampeners (pistons) the phase shift can be adjusted appropriately. Driving conditions of the balancing means in a given situation, e.g. for a particular scanner design, can be checked experimentally, e.g. by measuring parasitic motion, and adjusted accordingly.

Operation in harmony can be advantageously provided by using a controller, e.g. a single controller or frequency generator, to drive the driving dither and the one or more force balancing means. Optionally the driving dither and the one or more force balancing means can be controlled by individual control means configured to operate in harmony.

The term stationary or neutral center of the scanner body is intended to refer to a point, axis or even plane of equilibrium or center of displacement for a given resonance mode. For example for a breathing or stretching resonance mode of a free standing body the neutral or stationary center generally passes through its center of mass. Accordingly, the stationary or neutral center of the scanner body can refer to a neutral bending plane along a longitudinal axis of the scanner body 10. For bodies that are connected to a stationary reference frame, e.g. a metro frame of the scanning probe microscopy system, the stationary or neutral center is generally defined by said connection.

Further it will be understood that depending on circumstances undesired displacement or resonance of the scanner body due to forces imposed by the dither may be more or less noticeable. For example, potential displacements may be more noticeable with increasing moment of the resultant force imposed onto the scanner body by the driving dither relative to the stationary or neutral center, e.g. potential adverse displacements may increase with increasing driving force and/or more off-center or asymmetric placement of the driving dither relative to the scanner body. Alternatively, or in addition, displacements may be less noticeable with decreasing match or overlap between a driving frequency of the driving dither and an eigenfrequency of a particular resonance mode of the scanner.

The invention is described more fully hereinafter with reference to the accompanying drawings, in which embodiments of the invention are shown. In the drawings, the absolute and relative sizes of systems, components, layers, and regions may be exaggerated for clarity.

Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

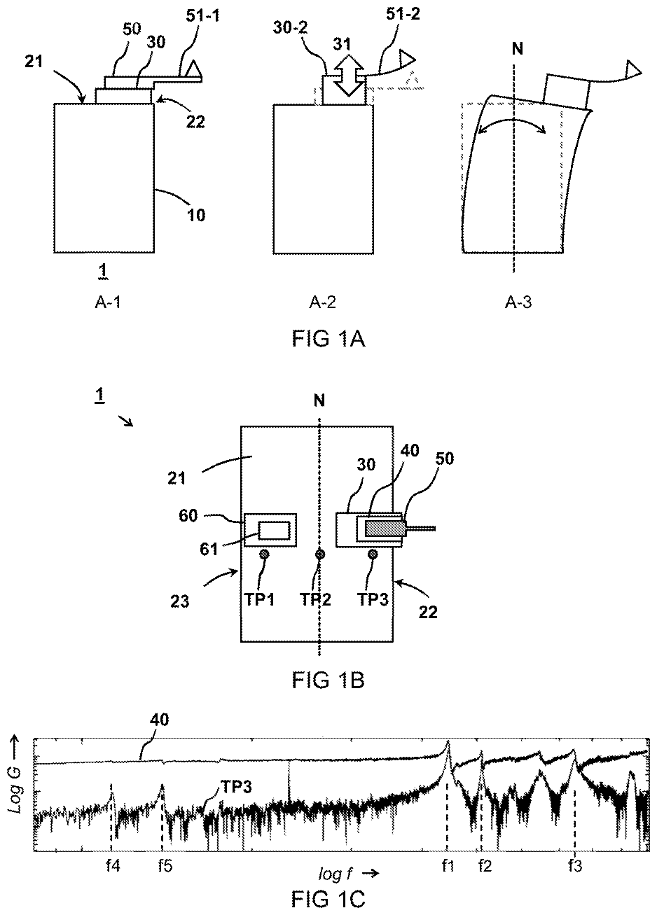

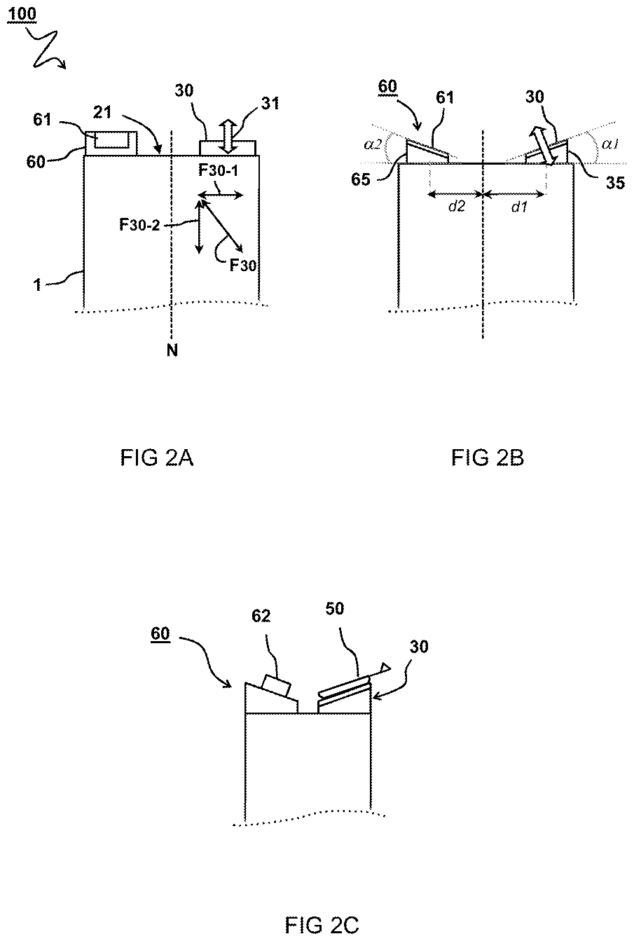

FIGS. 1A and B illustrate various aspects concerning resonance modes of a z-position motion stage 1 for use in a scanning probe microscopy system 100. FIG. 1A provides illustrative schematic side views of a z-position motion stage 1 at various stages A-1, A-2, and A-3, during operation. At stage A-1 the scanner is in rest. The scanner comprises a driving dither 30 mounted to a first terminal end face 21 of a scanner body 10. As shown the driving dither 30 is mounted off-center near a first edge 22 of the end face. A probe 50 chip including a cantilever 51 with a probe tip is associated to the driving dither 30, for example via a mount (not indicated for clarity). The motion stage generally also includes a large stroke z-motion actuator. The large stroke z-motion actuator is configured to provide a relative motion of the dither and a probe associated therewith along a z-direction. For reasons of clarity aspects relating to the balancing of the scanner are omitted from FIGS. 1A and 1B. These aspects and aspects relating to the large stroke z-motion actuator will be discussed in more detail with regard to FIGS. 2, 3, and 4.

Upon activating the driving dither provides an oscillating motion 31, as represented by a deformation, which may cause the cantilever to resonate at a corresponding resonance frequency, as shown in A-2. In addition to driving the cantilever the driving dither 30 imposes a net resultant force, an oscillatory force, onto the scanner body 10. As shown in A-3 this force, can in turn excite a bending or nodding resonance of the scanner body, as indicated by the double-headed arrow, across a neutral plane N along a longitudinal axis of the scanner body 10. Note that for simplicity of explaining the principle of parasitic motion the embodiments of the scanner is fixed to a stationary reference along a bottom end of the scanner body 10 opposite the first terminal end face 21. It will be appreciated that the principle of mitigating parasitic motion it not limited to such configurations and can be applied in general to scanners that have a fixed reference at a different position, e.g. at central position or at a side.

The force imposed by the dither is distinct from a force generated by a z-displacement actuator, e.g. a large stoke z-motion actuator, already because z-motion actuators are generally not operated to provide an oscillating motion along a z-direction and are generally even unsuited to excite a resonance mode of a cantilever probe, already due to their comparatively high mass (inertia) that is associated with the purpose of providing comparatively large displacements in dependence of a control parameter along the z-direction, e.g. during a landing operation or to enable following a z-topology of a substrate surface during a scanning operation.

FIG. 1B depicts a top view of a z-position motion stage 1 for use in a scanning probe microscopy system. Similar to the motion stage depicted in FIG. 1A the scanner is provided with a driving dither 30 which is provided along a first terminal end face 21 of the scanner body at a position near a first edge 22 thereof. A probe 50 including a cantilever is associated to the driving dither 30 via a mount 40, e.g. clamping or vacuum suction mount. In accordance with an object of the present disclosure, the motion stage comprises a means 60 to counteract a resonance of the scanner body. Said means, referred to as a first force balancing means 60, is provided along the first terminal end face 21 at a position near a second edge 23 opposite the first 22. The balancing means 60 comprises a first balance dither 61. The first balance dither is configured to oscillate in harmony with the driving dither. As shown, the first force balancing means acts onto the scanner body at a position opposite the driving dither 30 across a neutral center N of the motion stage, in this case a neutral bending plane along a longitudinal axis of the scanner body 10 (see also A-3 in FIG. 1A). In some embodiments, the force balancing means 60 comprises a single first balance dither 61 or stack of balance dithers. In some embodiments, e.g. as shown in FIG. 2B the force balancing means 60 can comprise an assembly of one or more balance dithers and a holder or mount.

It will be appreciated that the concept of mitigating scanner resonance as disclosed herein is not limited to scanners having a geometry or rectangular cross-section as depicted. The concept can be equally applied to scanners having arbitrary geometries and/or cross-sections such as elongate tubular scanners having a rounded cross-section.

FIG. 1C, illustrates displacement of the scanner at positions along the first terminal end face 21 of the scanner body 10 as function of the frequency the driving dither 30 is driven at. The top plot, marked 40, shows a frequency response of a cantilever associated to the driving dither as function of driving frequency. The peak at a frequency marked f1 corresponds to a resonance mode of the cantilever. The bottom plot, marked TP3, shows the frequency response G, as measured by optical interferometry, along the first terminal end face 21 of the scanner at a position marked TP3 in FIG. 1B. During recording the first force balancing means 60 was inactive. As can be observed from the presence of a number of peaks, the z-position motion stage can be excited at a number of frequencies or eigenfrequencies. The peak marked as f1 was found to correspond to a nodding or bending mode of the stage. It was found that the bending resonance was effectively suppressed upon activating the first force balancing means 60. Measurements at positions TP1 and TP2 showed comparable results. The resonances at f2 and f3 could likewise be suppressed. The resonances at f4 and f5 are considered less critical at least within the context of noise reduction during a scanning operation because the impact at these frequencies was found to be at least an order of magnitude (10 times) smaller (note the logarithmic scale along the vertical axis).

Now, various other or further aspects will be explained with reference to FIG. 2, wherein FIG. 2A provides a partial cross-section side-view of the embodiment shown in FIG. 1B and wherein FIGS. 2B and C show embodiments comprising further or additional features.

In one embodiment, e.g. as shown in FIG. 2A, the z-position motion stage 1 comprises at least a scanner body 10 and a driving dither 30 provided along a first terminal end face of the scanner body at a position near a first edge thereof. The driving dither 30 is configured to impart a first oscillation 31 for driving a cantilever of a probe (see FIG. 2C) associated to the driving dither in an oscillating motion. The stage further comprises at least a first force balancing means 60, acting onto the scanner body at a position opposite the driving dither 30 across a stationary or neutral center N of the motion stage 1. The force balancing means 60 comprises at least a first balance dither 61 that is configured to oscillate in harmony with the driving dither. At least in part due to the off-center positioning of the driving dither 30 the scanner body 10 experiences a resultant force F30 that imparts a moment onto the scanner during operation of the driving dither 30. Said force may be understood to comprise a lateral component F30-1 in a direction along the first terminal end face 21 and a vertical component in a direction along a longitudinal direction of the scanner body 10. As disclosed herein it was found that a net resultant force and the corresponding moment imposed onto the scanner body 10 by the driving dither 30 and balancing means can be effectively reduced, thus stabilizing the z-position motion stage 1, even when a driving frequency of the driving dither 30 coincides with a resonance mode of the scanner.

The magnitude of resultant force imposed by the balancing means, and conversely the magnitude of the net resultant force imposed onto the scanner body 10 during operation, can be advantageously controlled by controlling a driving amplitude of one or more of the first balance dithers. Controlling the amplitude was found to provide an effective way to regulate the force imposed on the scanner body by the balancing means. Thus the first force balancing means can be used to counteract a resultant force of the driving dither over a broad, even when for example the driving amplitude of the cantilever is changed during a surface probing operation or in-between subsequent operations.

In some embodiments, the z-position motion stage comprises a controller to drive the balance dither, preferably a single controller to drive the driving dither and any of the balancing dithers. Alternatively, the dithers may be controlled by a separate controller or a controller of the scanning probe microscopy system 100.

In a preferred embodiment, e.g. as shown in FIGS. 2B, the first force balancing means 60 is positioned from the stationary or neutral center N at a distance d2 that matches a distance of the driving dither 30 to the stationary or neutral center. Preferably the driving dither and first force balancing means 60 are positioned about equidistant from the stationary or neutral center N.

In other or further preferred embodiments, e.g. as shown in FIGS. 2B and 2C, the first force balancing means is oriented about mirror-symmetrically to the driving dither or probe mount across the stationary or neutral center of the z-position motion stage. Preferably the first balance dither 61 is provided under an angle α2 that matches a mounting angle α1 of the driving dither 30, e.g. by corresponding mounts 35 and 65 as shown.

Orienting the first force balancing means, in particular the first balance dither 61 about mirror-symmetrically to the driving dither across the stationary or neutral center of the z-position motion stage, was found to at least partly cancel out resultant forces imposed on to the scanner body in both lateral and longitudinal directions.

In some embodiments, e.g. as shown in FIG. 2C, the force balancing means 60 comprises a mount 62 for holding a balancing load. The mount 62 allows a user to adjust a mass displaced by the balancing dither. Adjusting the mass may be particularly beneficial as an additional or alternative means to control adjust the induced force imposed onto the scanner body by the first force balancing means. For example, the mount can be configured to hold a mass that corresponds to a mass of a probe chip 50 to be used. Thus allowing to conveniently balance the z-position motion stage 1 system even after a given probe chip is exchanged for a chip with a different mass.

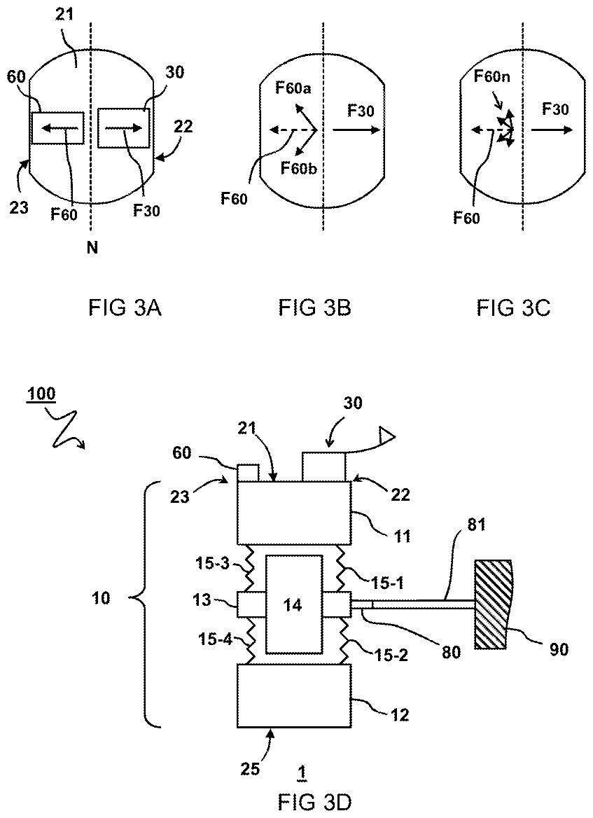

FIG. 3A to 3C provide schematic top views of other or further embodiments of a scanner with a force balancing means 60. In some preferred embodiments, as shown in FIG. 3A, the scanner may comprise a single force balancing means 60 positioned along the first terminal end face 21 of the scanner body at a position. As described herein the single force balancing means and the driving dither 30 can be positioned about equidistant, or even mirror symmetrically, relative to the stationary or neutral center N. Advantageously the force F60 imposed onto the scanner body 10 by the first force balancing means 60 can be controlled, so as to match a force F30 by the driving dither 30, in a number of ways including adjusting a driving amplitude and/or a mass displaced by the first force balancing means.

In other or further embodiments the first force balancing means 60 comprises a plurality of separated balance dithers distributed in an arrangement as to jointly at least partly cancel out the net resultant force F30 induced by the driving dither. In one embodiment, e.g. as shown in FIG. 3B the first force balancing means 60 comprises a first and a second balancing dither, that respectively generate resultant forces F60a and F60b, which add up to form a resultant force F60 that at least partly cancels out a resultant force F30 by the driving dither. It will be appreciated that the first force balancing means 60 can in principle comprise any number of balancing dithers such as 3, 5 or ‘n’ number of dithers to generate a resultant relevant balancing force F60n. Advantageously provision of a plurality of balancing dithers can improve balancing of the z-position motion stage along a plurality of directions, allowing mitigation of complex resonances, such as a potential twisting resonance around a longitudinal axis of the scanner body. In addition embodiments comprising a plurality of separated balancing dithers, as compared to embodiments using a single balancing dither, provide a similar effect as to mitigation bending oscillations using comparatively smaller dithers, which can provide a space benefit along a terminal end surface of the z-position motion stage, for example near edge 23.

In some embodiments, e.g. as shown if FIG. 3D, the scanner body 10 comprises a central member 13, and a first end member 11, a second end member 12, that is positioned across opposite ends of the central member 13. As shown, the first terminal end face 21, as for example described in relation to FIG. 2A, is defined by the first end member 11. The second end member, opposite the first, defines a second terminal end face 25 of the scanner body 10. The first and second end members 11,12 are attached to the central member 13 by one or more spring members 15, e.g. blade springs. The central member 13 is preferably reversibly connectable to a metro frame 90 of a scanning probe microscopy system 100. Further aspects in relation to the scanning probe microscopy system 100 will be provided later. The central member 13 generally comprises at least one large stroke actuator 14 that acts onto the first and second end members 11,12 as to provide a translation in a direction transverse, preferably orthogonal, to the first terminal end face 21. Combining a driving dither and a z-positioning actuator in a single stage, a z-position motion stage, may be advantageous for a number of reasons, including interchangeability of one or more motion stages with one or more scanning probe microscopy systems.

The flexible connection, via spring members 15, advantageously provides the scanner body 10 with a suitable compliance to accommodate displacements by the large stroke actuator 14. At the same time the construction with flexible connection can be understood to affect resonance modes and frequencies within the scanner body 10, e.g. a bending or nodding resonance of the first end member 11. To mitigate such potential resonances the scanner body 10 is provided with balancing means 60 as described herein.

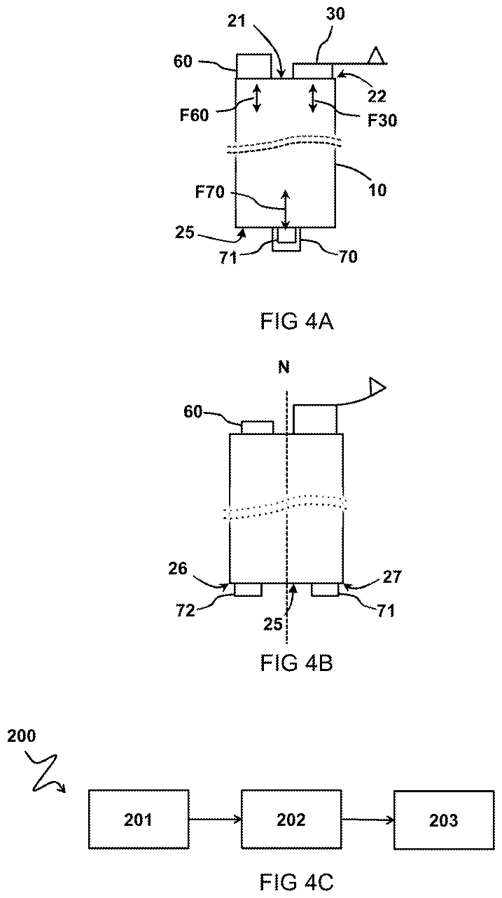

In other or further preferred embodiments, e.g. as shown in FIGS. 4A and 4B, the motion stage comprises at least a second force balancing means 70 positioned along a second terminal end face 25 of the scanner body 10 opposite the first terminal end face 21. Provision of the at least one second force balancing means 70 was found to mitigate resonance, e.g. an stretching or breathing mode, of the scanner body 10 along an axial direction between opposing end faces of the 10. Similar to the first force balancing means 60 the second force balancing means 70 comprises one or more second balance dithers 71 that are configured to oscillate in harmony with the driving dither and the first force balancing means 60 if provided. In one embodiment, e.g. as shown in FIG. 4A, the z-position motion stage comprises a driving dither 30 and a first force balancing means 60 provided along the first terminal end face 21 of the scanner body 10, e.g. of a first end member 11 as shown in FIG. 3D, and a single second force balancing means 70 positioned along the second terminal end face 25 of the scanner body 10, e.g. of a second end member 12. The second force balancing means 70 can, during use, advantageously generate a resultant so that, in use, a resultant force F70 induced by the second force balancing means 70 at least partly cancels out a net resultant force F30 induced by the probe and/or the first force balancing means F60 in a longitudinal direction between the first and second terminal end faces 21,25.

In some embodiments, e.g. as shown in FIG. 4B, the second balance means comprises at least two second balance dithers 71,72 distributed at positions along the second terminal end face 25. Each preferably position opposite the driving dither 30 and the force balancing means 60, e.g. near opposing edges 26, 27 of the second terminal end face 25. Provision of at least two second balance dithers 71,72 can advantageously mitigate resonance modes in a second end member 12 and/or mitigate resonance modes in the scanner body 10 as a whole in both lateral and longitudinal directions.

It will be appreciated that the z-position motion stage according to the present disclosure can be used to advantage in scanning probe microscopy system, e.g. as shown in FIG. 3D.

In one embodiment, the scanning probe microscopy system 100 comprises a z-position motion stage 1, preferably a z-position motion stage 1 as disclosed herein, more preferably a z-position motion stage as described in relation to FIG. 3D. Typically the z-position motion stage comprises a mount 80 for reversibly associating the z-position motion stage to the scanning probe microscopy system 100, e.g. to a metro frame 90 of the scanning probe microscopy system 100. Alternatively, the z-position motion stage 1 may be an integral part of the scanning probe microscopy system 100.

Preferably, the scanning probe microscopy system comprises a coarse translation means 81 that acts on the z-position motion stage 1, preferably via the mount, so as to, in use, position the motion stage 1 opposite an area of interest along a surface of a substrate to be probed. Alternatively, or in addition, the scanning probe microscopy system 100 can comprise a coarse translation means that acts onto a sample to be probed and/or only a holder or sample stage for holding one or more substrates to be probed.

In some embodiments, the scanning probe microscopy system 100 comprises a detector, e.g. an optical position detector such as a interferometry system, or strain gauge system, for detecting one or more of a bending, stretching and/or other resonances of the scanner body, for example by detecting a lateral and/or longitudinal displacement of a face, e.g. the first terminal end face of the scanner body.

Yet further or other aspects of the present disclosure relate to a use or method of operating the z-position motion or scanning probe microscopy system 100 as disclosed herein. The method comprises operating 203 the first and or further force balancing means in harmony with the driving dither at least while the driving dither is driven, in particular while the driving dither is driven at a frequency associated with a resonance mode of the scanner body. Driving the balancing means counter acts a resultant force imposed onto the scanner body by the driving dither and thus mitigates a potential response of the scanner. In some embodiments, the balancing means is switched off while the driving dither is operated at a frequency that does not overlap with an eigenfrequency of the scanner body. However, it will be appreciated that this is not a prerequisite. The one or more balancing means can be operated in harmony with the driving dither even when the driving dither is operated at a frequency that does not overlap with an eigenfrequency of the scanner body.

In one embodiment, e.g. as shown in FIG. 4C, the method further comprises: associating 201 a probe to the z-position motion stage. In another or further embodiment, the method comprises and driving 202 the driving dither, typically at a target driving frequency associated with a target resonance mode of a cantilever of the probe; and operating 203 the first force balancing means in harmony with the driving dither at least while the driving dither is driven at a frequency associated with a resonance mode of the scanner body. Driving the driving dither and the first and further force balancing means in harmony as disclosed herein advantageously mitigates noise and parasitic forces, e.g. during probing an area of a substrate of interest, due to undesired translations from an resonance mode of the scanner body.

In some embodiments, the method comprises sweeping the driving dither over a sweeping range to detect a target resonance frequency range of the cantilever and corresponding target operating oscillation frequency of the driving dither. Alternatively, a target resonance frequency may be determined using other known means, e.g. thermally. In other or further embodiments, the method comprises sweeping the driving dither to detect a resonance mode of the scanner body within the sweeping range, e.g. using optical interference spectroscopy. Advantageously, operation of the force balancing means can be made conditional to occurrence of a resonance mode in a levant driving range. In a preferred embodiment, the method comprises comparing the detected resonance frequencies of the cantilever and the scanner body and driving one or more of the first force balancing means and the second force balancing means when the target resonance range overlaps with a detected mode of the scanner body. Alternatively operation of the force balancing means can be made conditional to overlap of a target driving frequency with a predetermined resonance mode of the scanner body. In a preferred embodiment, the method further comprises determining whether the target driving frequency falls within a range associated to one or more a bending resonance mode of the scanner body; and a longitudinal resonance mode of the scanner body. Advantageously operating the first and/or further force balancing means can be operated only if the driving frequency is within the range. This limits operating the balancing means to conditions wherein the effect of a net resultant force induced by the driving dither is most noticeable.

For the purpose of clarity and a concise description, features are described herein as part of the same or separate embodiments, however, it will be appreciated that the scope of the invention may include embodiments having combinations of all or some of the features described. Of course, it is to be appreciated that any one of the above embodiments or processes may be combined with one or more other embodiments or processes to provide even further improvements in finding and matching designs and advantages.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. A z-position motion stage for use in a scanning probe microscopy system comprising:
a scanner body; and
a driving dither provided along a first terminal end face of the scanner body at a position near a first edge thereof, that is configured to impart a first oscillation for driving a cantilever of a probe associated to the driving dither in an oscillating motion,
thereby exciting a resonance mode of said cantilever of said probe,
wherein the stage further comprises at least a first force balancing means, acting onto the scanner body at a position opposite the driving dither across a stationary or neutral center of the motion stage, said stationary or neutral center of the motion stage being a neutral bending plane (N) along a longitudinal axis of the scanner body, and wherein the force balancing means comprises at least a first balance dither configured to oscillate in harmony with the driving dither.

2. The motion stage according to claim 1, wherein the first force balancing means is positioned relative to the driving dither so that, in use, a net resultant force induced in a direction along the first terminal end face at least partly cancels out a net resultant force induced by the driving dither.

3. The motion stage according to claim 1, wherein the first force balancing means is provided along the first terminal end face of the scanner body at a position near a second edge thereof.

4. The motion stage according to claim 1, wherein the first force balancing means comprises a plurality of separated balance dithers distributed in an arrangement as to jointly at least partly cancel out the net resultant force induced by the driving dither.

5. The motion stage according to claim 1, wherein the first force balancing means is oriented mirror-symmetrically to the driving dither across the stationary or neutral center.

6. The motion stage according to claim 1, further comprising a second force balancing means positioned along a second terminal end face of the scanner body opposite the first terminal end face, wherein the second force balancing means comprises one or more second balance dithers configured to oscillate in harmony with the driving dither.

7. The motion stage according to claim 6, wherein the second balance means comprises at least two second balance dithers distributed at positions along the second terminal end face opposite the driving dither and the force balancing means.

8. The motion stage according to claim 1, wherein the scanner body comprises a first end member defining the first terminal end face and a second end member defining the second terminal end face, the first and second end members positioned across opposite ends of central member that is reversibly connectable to a metro frame of the scanning probe microscopy system, wherein the central member comprises a large stroke actuator acting on the first and second end members so as to provide a translation in a direction transverse to the first terminal end face, whereby each of the first and second end members is attached to the central member by one or more spring members.

9. The motion stage according to claim 1, wherein the first and/or second force balancing means comprise a mount for holding a balancing load.

10. A scanning probe microscopy system comprising a z-position motion stage according to claim 1 and a mount for reversibly associating the z-position motion stage to a metro frame of the scanning probe microscopy system.

11. The scanning probe microscopy system according to claim 10,
comprising a coarse translation means acting on the z-position motion stage, so as to, in use, position the motion stage opposite an area of interest along a surface of a substrate to be probed.

12. The scanning probe microscopy system according to claim 10, comprising a detector for detecting one or more of a bending resonance of the scanner body; and a longitudinal resonance of the scanner body.

13. A method of operating a scanning probe microscopy system according to claim 10, comprising:
associating a probe to the z-position motion stage,
driving the driving dither at a target driving frequency associated with a target resonance mode of a cantilever of the probe, and
operating the first force balancing means at least when the driving dither is driven at a frequency associated with a resonance mode of the scanner body.

14. The method according to claim 13, further comprising:
operating the second force balancing means at least when the driving dither is driven at a frequency associated with a resonance mode of the scanner body.

15. The method according to claim 13, further comprising determining whether the target driving frequency falls within a range associated to one or more of a bending resonance mode of the scanner body; and a longitudinal resonance mode of the scanner body.

16. The motion stage according to claim 8, wherein the direction transverse to the first terminal end face is orthogonal to the first terminal end face.

17. The scanning probe microscopy system according to claim 11, wherein the coarse translation means acts on the z-position motion stage via the mount.

18. A method of operating a z-position motion stage according to claim 1, comprising:
associating a probe to the z-position motion stage,
driving the driving dither at a target driving frequency associated with a target resonance mode of a cantilever of the probe, and
operating the first force balancing means at least when the driving dither is driven at a frequency associated with a resonance mode of the scanner body.
